(19) United States
(12) Patent Application Publication
(10) Pub. No.: US 2008/0081695 A1
(43) Pub. Date: Apr. 3, 2008

(54) Viewer Interactive Event System

(76) Inventor: Jeffery Allen Patchen, Hermosa Beach, CA (US)

Correspondence Address: MCDERMOTT WILL & EMERY LLP, 2049 CENTURY PARK EAST, 38th Floor, LOS ANGELES, CA, 90067-3208, US

(21) Appl. No.: 11/866,314

(22) Filed: Oct. 2, 2007

Related U.S. Application Data
(63) Continuation of application No. 10/173,374, filed on Jun. 14, 2002, now abandoned.
(60) Provisional application No. 60/298,396, filed on Jun. 14, 2001.

(51) Int. Cl. G06F 17/00

(52) U.S. Cl. 463/40

(57) ABSTRACT

An Internet or phone polling system provides audiences of competitive events the opportunity to interact with these events by determining which contestants may compete and the activities the contestants will perform. The audience may then judge the performance of each contestant by rating performances. The audience members compete against one another by predicting the overall top rated contestants. The audience members compete against one another while controlling and determining the outcome of the competitive event they are viewing. The system provides viewers as well as the contestants a chance to win awards, cash and prizes as a result of their participation.

### CROSS-REFERENCE TO RELATED APPLICATIONS

This application is a continuation of U.S. patent application Ser. No. 10/173,374, filed Jun. 14, 2002, entitled “Viewer Interactive Event System,” which claimed priority to U.S. Provisional Application Ser. No. 60/298,396, filed on Jun. 14, 2001, entitled “Method and systems of viewer interactive competitive event games.” The content of both of these applications is incorporated herein by reference.

### TECHNICAL FIELD

The present application relates to an interactive event system in which remote users participate via electronic communications media, for example, a method and system in which remote viewers participate in the production of events, while being able to win cash or prizes as a result of their participation.

### BACKGROUND

Over the years, many new competitive events have been created in an attempt to achieve the level of success that has been attained by popular events. In order to entice and maintain a large audience base, the new events have employed a wide variety of formats and themes. However, in spite of the extraordinary effort that has been expended in developing new popular competitive events and their formats, no event has been able to attain multiple levels of a direct, real interaction between the competitive event itself and the home viewing audience.

In particular, viewers of, for example, reality-based television competitions, are able only to participate in that competitive event amongst themselves or at a very minimal input, such as voting to expel a house member in a show such as Big Brother, without being able to share in the prize awards given to the on-camera participants.

### SUMMARY

A viewer-interactive event system receives viewer input from a number of viewers, e.g., via an interactive web site or telephone polling other interactive means such as digital cable television. The viewer input may include votes for contestants in a competition and selected activities for the contestants to perform in a subsequent audition production. The system generates production information identifying the contestant(s) and activity(-ies) selected by the highest number of viewers. Viewers may receive points for correctly guessing the contestants selected for the audition production. After viewing the audition production, viewers may rate the contestant's performance. One or more winners may be selected based on viewer ratings. The winner(s) may be cast in a subsequent production, e.g., a television program or movie. Viewers may also receive points for voting for the winner(s). Viewers may receive prizes based on the number of points they accrue.

Among other features, the system described here comprises a game for viewers of competitive events to allow viewing of these events and to receive game points for participating. The system may ensure that the viewers remain unbiased in their decisions. This is due to the fact that points are received in the process of selecting the semi-finalists of an event who are selected by the highest number of all viewers combined.

In essence, there may be two competitions running simultaneously, the audience competing against one another on one level and the contestants who are controlled by the audience competing on another level. This system contains a contest within the game. The system is a viewer-controlled competition within a game where the viewers as well as the contestants receive cash and prizes as a result of their participation.

The system may provide a system to manufacturers, retailers, and others with information on groups or individuals regarding their likes and dislikes and/or what is most appealing to them.

An advantage of the system is in increasing the audience enjoyment of televised and video-taped competitive events.

Another advantage is an improved interactive method allowing participants to interact with a competitive event by controlling the activities performed during the event.

The systems and techniques described here allow a Web site to be constructed in order to add or eliminate elements according to the type and theme of each competitive event. Therefore, the Web site can be used for viewers to participate in a competitive event one month and another competitive event the following month on the same site. The Web site may also be able to accommodate various types or themes of events.

Still a further advantage is in increasing the level of knowledge of a participant to an event such as a political campaign.

Today televised competitive events have no or very little viewer interactivities compared to the system described within this document. Viewers may be more inclined to pay to see an event if they not only have the opportunity to become interactive with the event but control its content and format as well. As a bonus they may have the chance of winning cash, prizes and awards as a result of their participation.

Many game shows and competitive events are produced by companies who would prefer not to let the audience have any control over who competes, the activities they may perform during the event and the judging aspects of the event. In contrast, the system described here has the capability to eliminate the political inclinations of the producers of these events and at the same time provide audiences with a feeling of empowerment.

The system increases both the intellectual and emotional enjoyment to a participant viewing a competitive event as someone who is now empowered and driven to be critical of the event knowing that they have a voice in determining not only the outcome of an event but the overall event as well.

Still a further advantage is in increasing the satisfaction of a viewer knowing that a decision was made not by the politically motivated few but the many who are disheartened with being presented with a decision in which they did not participate.

### BRIEF DESCRIPTION OF THE DRAWINGS

FIG. 1 is a block diagram of a viewer-interactive event system according to an embodiment.

FIG. 2 illustrates web pages in a web site according to an embodiment.

FIG. 3 illustrates phases in a competitive event series according to an embodiment.

### DETAILED DESCRIPTION

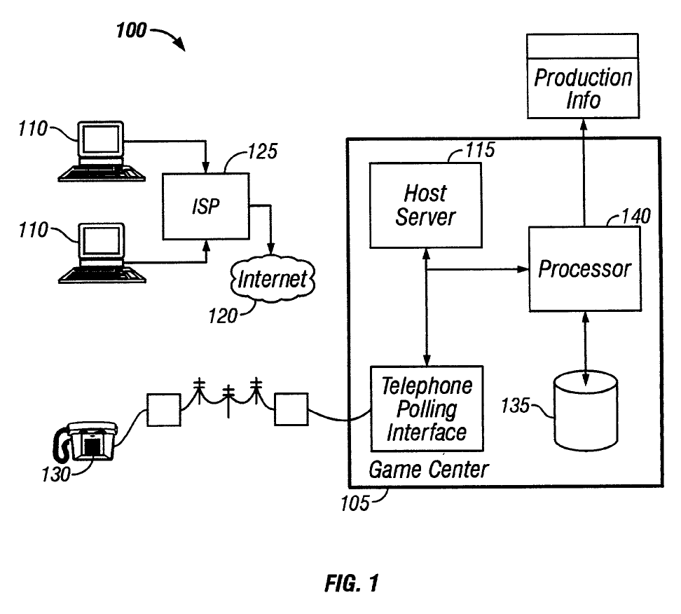

FIG. 1 illustrates a viewer-interactive event system 100 according to an embodiment. The system 100 includes a game center 105. The game center 105 is used to host interactive events which enable viewers to compete against each other in selecting and judging contestants in a competition. The contestants may be, for example, actors or models competing to be cast members in a production (e.g., a television series or movie), political candidates, characters for a cartoon or video game, or products. Viewers may receive points for, among other things, correctly guessing the winner of the competition. Viewers with the highest points may receive prizes. The prize structure may provide viewers with an incentive to participate.

The viewers may use a viewer input device, such as network-capable (client) computers 110, to connect to a receiver at a host server 115 at the game center 105. The client computer 110 may use, e.g., a modem to connect to the Internet 120 through an Internet Service Provider (ISP) 125. The host server may host a web site that includes one or more HyperText Markup Language (HTML) compatible web pages. The web pages can be accessed via the HyperText Transfer Protocol (HTTP) and displayed by an HTML compatible Internet 120 browser running on a client computer 110.

A viewer may enter selections using a client computer 110. Alternatively, the viewer may enter selections using a telephone keypad 130 in response to verbal prompts. The game center 105 stores contestant and viewer scores in a database 135. A processor 140 may use the information in the databases to determine winners (both contestants and viewers) and generate production information 150 including elements selected by the majority of viewers.

A viewer-interactive competitive event may include contestants (e.g., persons, animals, characters, products), activities (actions, scenarios and/or positions that each contestant may be required to perform), and viewers and/or a point system. Some examples of events that may be implemented in the system include, for example, beauty and talent competitions, body building competitions, toy design competitions, political and/or other types of elections.

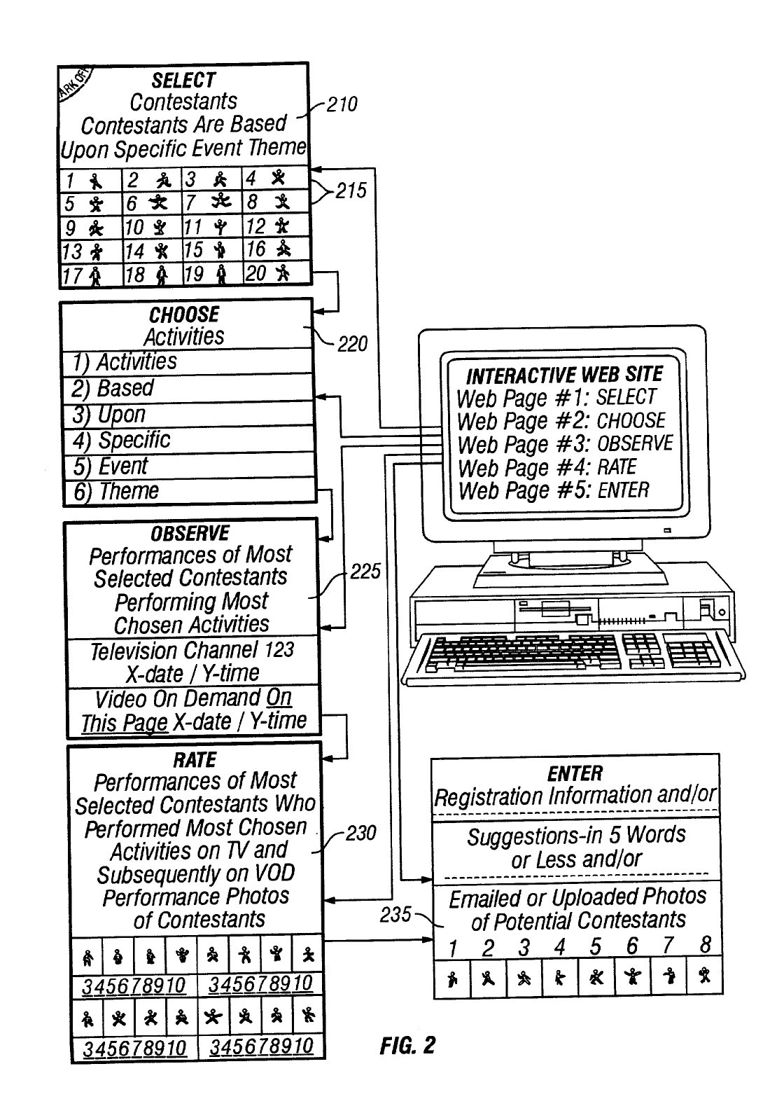

An event may have several phases. During each phase, the Web site may provide various interactive elements in order for the viewers to perform the tasks during their event participation. The web site describes each of the phases of a specific competitive event series as well as the interactive process that offers each viewer the opportunity to participate in the event, as shown in FIG. 2.

Each page of the Web site during this, the first phase, provides viewers with a specific interactive function. The Select page 210 of the Web site begins the first step of the viewer's decision-making process. Several weeks prior to the first TV broadcast of the series, photographs of contestants are posted on this page of the Web site. The contestants can be posted as thumbnail photographs, photographs, and/or videos. Registered viewers are required to select contestants (e.g., up to five) that they would like to see audition on the next show of series. During the first and every other broadcast of the series, new photographs of contestants and/or contestant's products may be shown to the TV viewers by displaying those photographs that have been uploaded onto the Web site during the time of broadcast. From the time the photographs are displayed to the audience from the Web site during the broadcast, viewers are required to select up to five contestants during the next 48 hours, that they would like to see perform on TV during next TV broadcast or the subsequent video-on-demand following the broadcast that is a result of that broadcast. The contestants that receive the overall highest number of selections by all viewers combined will appear on the next TV broadcast.

Viewers are then directed to the Choose page 220 to perform the required weekly choice process. The Choose page of the Web site begins the second step of the viewer's decision-making process. Several weeks prior to the first TV broadcast of the series, activities for the selected contestants to perform will be posted on this page of the Web site. Registered viewers will be required to select activities (e.g., up to five) that they would like to see their selected contestants perform on the first show of series. During the first and every TV broadcast of the series, the original activities that were posted prior to the first show may be displayed to the TV viewers during the broadcast. This will be primarily for the benefit of the viewers that registered to participate after the series has begun and for the benefit of the contestants. From the time activities are displayed during the TV broadcast, viewers will have 48 hours to select up to five of the activities that they would like to see performed on the next TV broadcast by their selected contestants. The activities that are chosen the overall highest number of times by all viewers combined will be performed by the contestants that receive the overall highest number of selection votes by all viewers combined on the next TV broadcast.

The activities may be posted on the Web site. Photographs, thumbnail photographs or videos of, and/or text describing persons and/or products performing activities may be posted.

Viewers are then directed to the Observe Page 225 to perform the required weekly observe process. The Observe page of the Web site begins the third step of the viewer's decision-making process. Several weeks prior to the first TV broadcast of the series, channels, dates and times will be posted on this page of the Web site and are consistent throughout the series.

Registered viewers are required to observe every performance of the series. This can be accomplished in two ways, by observing their performance on the specified TV channel at the specified time, or by observing the performance on the Web site video-on-demand several days after the TV broadcast.

Viewers are then directed to the Rate Page 230 to perform the required weekly rating process. The Rate page of the Web site is the fourth step of the viewers decision-making process. Photographs of the contestants that have been selected to appear on the TV broadcast each week are posted on this page of the Web site immediately after their TV audition performance has been completed.

When the contestants' photographs have been posted on this page, there is a number scale, e.g., 1 to 10, posted under each photograph. This is the rating that is entered into the database 135 to be averaged after all ratings have been submitted in the allotted amount of time. Ratings may be entered after the TV broadcast and/or anytime up to 48 hours after the last audition of the series has been made available on the Web site video-on-demand. On this page of the Web site, registered viewers have access to the database 135 and are provided with the opportunity to change their ratings of any previously rated contestants and/or contestant products.

Viewers are then directed to the Enter Page 235 to perform the required weekly entering process. The Enter page of the Web site is the fifth step in the viewer's interactive decision-making process. Here viewers must enter registration information such as their email address, user name, password as well as city and country in order to have their selections, choices and ratings entered into the database 135 and to become eligible to win cash and prizes as a result of their participation.

When viewers enter their city and country, the system will have the necessary information to be able to direct them to the TV channel and time of broadcast that is available in their specific demographic. This will also provide information necessary to divide global or territorial regions in order to compile information on what appeals to specific regions versus all regions as a whole.

Each viewer's ratings during the season will be entered into a database that is accessible to that viewer at anytime during the series by entering their user name and password.

When the last audition of the series has been completed on television and becomes available on the Web site video-on-demand, viewers are given 48 hours to complete the required task during phase two of the series. After the last TV audition of the series becomes available on the Web site video-on-demand, viewers will have 48 hours to list their top ten highest rated contestants in order from 1st thru 10th place.

Viewers are then directed to the Rate page. Viewers will be instructed to access the ratings database and review the ratings they have given each contestant during the series. Blank entry lines numbered 1 thru 10 are posted. Viewers will have five days prior to the final show of the series to list their top ten highest rated contestants of the series in the order of 1st through 10th place in the blank entry lines. The points structure may be, e.g., 10 points for first place, 9 points for second place, 8 points for third place and so on, with the tenth place contestant receiving 1 point. The overall 1st thru 10th place contestants are determined by totaling the points of each contestant listed. For example, if the series has 1000 registered viewers, a contestant listed as 1st place, which is worth 10 points, by 999 viewers and not listed by one viewer, may receive 9,990 points. The contestant(s), or finalist(s), with the highest number of points are determined the winner(s) of the competition. The final show of the series showcases the finalists of the series. The winning viewer may also be posted on the Web site during the final show, along with their cash amounts and prizes received.

The viewer that has on his or her list of top ten contestants the same as the overall top ten contestants according ratings of all viewers combined may be announced as the winning viewer during the final show of the series. Alternatively, viewers may be awarded points and the viewer with the highest number of points wins. For example, if a viewer lists contestant #1 as their first place contestant prior to the final show, that viewer may receive the same point value as the contestant may receive, which is 10 points. If a viewer has on their list of contestants in the order of 1st thru 10th place the same contestants and in order as the overall 1st thru 10th place contestants, the maximum points that viewer would receive is the accumulated points of 1st thru 10th place, which is:
10+9+8+7+6+5+4+3+2+1—55 points

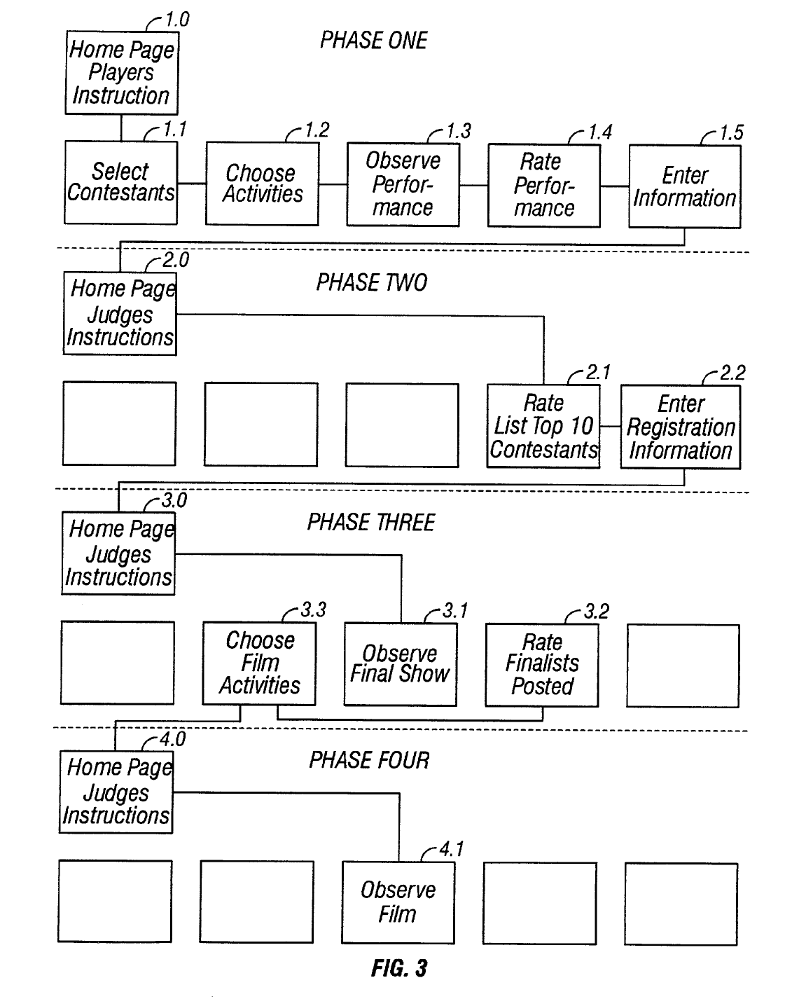

When viewers have completed the required tasks of Phase two, they are directed to proceed to Phase Three, as shown in FIG. 3. Viewers are instructed to visit the Observe page of the Web site in order to view the final show of the series, which will showcase the finalists of the series and announce the winning viewer(s). The TV channel time and date of the final show is posted. The time and date that the Web site video-on-demand will be available is also posted.

Viewers are then directed to the Rate page. Photographs of the series overall top ten highest rated contestants in order from 1st thru 10th place are posted. The winning viewer is also posted along with the amount of cash and the prizes that are awarded. Viewers that introduce contestants to the series who have become one of the overall top ten finalists will be listed.

Viewers are then directed to the Choose page. This page of the Web site will now have new activities, actions and/or scenarios posted. These are the activities that the finalists will be required to perform while starring in an upcoming production (e.g., movie or television program or series). Each viewer is asked to choose up to five activities. The production may be made available on the Web site, video-on-demand, broadcast TV, cable TV, and/or Pay-Per-View TV. Viewers will be given the channel, times and dates that the production will be available

If two or more contestants or viewers receive the same point total a drawing may take place. A participant in the game may change the ratings of one or all prior rated contestants at anytime prior to the deadline set forth as when the rating of all contestants must be submitted in order for the viewer to be provided a chance to win the prize award(s)

In different types of competitive events, different constraints may be applied to how and when a viewer can change the rating that they have already submitted. Other score calculation formulas may be employed as well.

In an embodiment, the system 100 prevents this type of interaction due to the nature of the scoring system 100. The scoring system 100 allows viewers to obtain a point value for pre-determining which contestants may finish as one or more of the finalists. This way, if a viewer wants to have a chance of winning the available prizes, the viewer must take into consideration who or what the other viewers may determine as a finalists or a winner.

The system 100 may drive viewers who registered to participate and win prizes to observe the event that follows each selection and choosing process. The viewer may want to view the event more than once in order to make a more effective rating due to the cash and prize that may be available.

In one embodiment, the system 100 may be used to host a beauty competition for selecting a host for a television series. The viewer is presented with a number of pages. The pages may be presented as Web pages or physical pages, for example, as an insert for a magazine. The viewers may input their selections using a client computer 110 via the host server or with a telephone via a telephone polling interface 160.

A number of contestants are presented in the Select page. The contestants may be presented in thumbnail photos. On a Web page, the photos may be linked to other information about the contestants, such as bios, larger photos, and/or video clips. The user selects and ranks a number of contestants, e.g., 1st through 4th.

Activities for the contestants to perform are presented in the Choose page 220. The choices may include questions to answer, scenarios to perform (e.g., perform a task or talent, or demonstrate a product), and/or apparel items to wear. The viewers' selections may be stored in the database 135. This information may be used to determine the contestants and activities selected by the majority of viewers.

The product and/or apparel displayed on the Choose page may be sponsor products. The Choose page may provide the sponsor with an advertising opportunity as well as customer preference information based on viewers' selections.

A production, e.g., a video or television program, may be produced using the winners performing the activities selected by the majority of viewers. The Observe page may indicate when and where this production may be broadcast (e.g., telecast, Webcast, pay-per-view) or distributed (e.g., on DVD). There will be some lag time between the end of voting and the broadcast, e.g., 48 hours, to allow time for the production.

The game aspect of this portion of the event is that viewers may receive points for correctly guessing the contestants selected by the highest number of viewers. The points may be based on selecting one of the winners and for selecting them in the proper order. For example, a viewer who votes for all four of the winners in the correct order may receive a highest possible score. Viewers may also receive points for selecting the activities selected by the majority of viewers in the correct order. These points may be referred to as “Select Points.”

After observing the production, the viewers may then rate the contestants in different categories, for example, based on their performances in an interview and another selected activity and for sex appeal. The possible scores may be, e.g., 1-10. The different categories may be weighted differently, e.g., Interview*30%, Activity*30%, and Sex Appeal*40%. A winner may be determined based on the total of the scores. The winner may then be cast as the host of the proposed television series.

A viewer may receive points for selecting the overall winner. These points may be referred to as “Cast Points.” Viewers may win cash and prizes based on their overall points (i.e., Select+Cast points). A drawing may be conducted in the event of a tie.

A number of embodiments have been described. Nevertheless, it may be understood that various modifications may be made without departing from the spirit and scope of the invention. Accordingly, other embodiments are within the scope of the following claims.

We claim:

1. A method comprising:
presenting a competition to a plurality of viewers, said competition comprising a plurality of competition elements;
receiving responses to said plurality of competition elements from said plurality of viewers;
identifying at least one competition element from said plurality of competition elements receiving a highest number of responses from said plurality of viewers; and
assigning a point value to viewers based on said highest number of responses from said plurality of viewers.

2. An apparatus comprising:
a receiver operative to receiver viewer responses from a plurality of viewer input devices, said viewer responses including information indicative of a plurality of competition elements;
a processor operative to assign points to viewers in response to received viewer responses and to generate competition information in response to received viewer responses, said competition information including information indicative of at least one competition element in said plurality of competition elements selected by a highest number of viewers; and
a memory operative to store viewer responses and viewer information including viewer points.

3. The apparatus of claim 2, wherein the viewer responses further include information indicative of responded to activities, and wherein said competition information includes activities responded to by said highest number of viewers.

4. The apparatus of claim 2, wherein the processor is further operative to assign points to a viewer in response to receiving a viewer response from said viewer matching a response by a majority of said viewers.

5. The apparatus of claim 2, wherein the receiver is further operative to receive ratings of said plurality of competition elements in an interactive event generated in response to said competition information.

6. The apparatus of claim 5, wherein the receiver is further operative to assign viewer points in response to said viewer responses and said ratings.

7. The apparatus of claim 2, wherein the plurality of viewer input devices include a plurality of telephones.

8. The apparatus of claim 2, wherein the plurality of viewer input devices include a plurality of networked computers.

9. The apparatus of claim 2, further comprising a server hosting a website including a plurality of interactive pages.

10. The apparatus of claim 2, wherein the processor is further operative to determine prize awards in response to viewer points.

11. The apparatus of claim 2, wherein the memory comprises at least one database.

12. An article comprising a machine-readable medium including machine-executable instructions, the instructions operative to cause a machine to perform operations including:
receive competition element responses from a plurality of viewers, each of said competition element responses based on at least one competition element responded to by said plurality of viewers from a plurality of competition elements;
generate competition information based on said competition element responses; and
assign a point value to said plurality of viewers based on at least one competition element response received from said plurality of viewers.

13. The article of claim 12, wherein the competition information comprises information identifying at least one competition element responded to by said plurality of viewers.

14. An article comprising a machine-readable medium including machine-executable instructions, the instructions operative to cause a machine to:
present an interactive event to a plurality of viewers, said interactive event comprising a plurality of competition elements;
receive responses from said plurality of viewers;
select at least one competition element from said plurality of competition elements based on the received responses;
assign points to viewers that responded to at least one of said plurality of competition elements; and
create a product based on said selected at least one competition element.

15. The article of claim 14, further comprising instructions operative to cause the machine to award a prize to at least one viewer based on a number of points assigned to said at least one viewer.

16. The method of claim 1, wherein said plurality of competition elements comprises at least two contestants.

17. The method of claim 1, wherein said plurality of competition elements comprises at least two products.

18. The method claim 1, wherein receiving responses comprises receiving ratings for the plurality of competition elements from the plurality of viewers.

19. The method claim 1, wherein receiving responses comprises receiving rankings for the plurality of competition elements from the plurality of viewers.

20. The method of claim 1, wherein receiving responses comprises receiving votes for the plurality of competition elements from the plurality of viewers.

21. The method of claim 1, further comprising awarding a prize to at least one viewer in the plurality of viewers based on an assigned point value to said at least one viewer.

22. The method of claim 1, further comprising including at least one of said plurality of competition elements receiving responses from said highest number of said plurality of viewers into a product.

23. The method of claim 22, wherein said product comprises a television show.

24. The method of claim 22, wherein said product comprises a movie.

25. The method of claim 22, wherein said product comprises a video game.

26. The method of claim 22, wherein said product comprises a cartoon.

27. The method of claim 22, wherein said product comprises a publication.
